(19) United States
(12) Patent Application Publication
(10) Pub. No.: US 2012/0222759 A1
(43) Pub. Date: Sep. 6, 2012

(54) NON-RETURN VALVE HAVING TWO CLOSING BODIES

(75) Inventors: Wolfram Knis, Schwaebisch Gmuend (DE); Uwe Ehrhardt, Ostfildern (DE); Tilman Miehle, Waiblingen (DE)

(73) Assignee: Robert Bosch GMBH, Stuttgart (DE)

(21) Appl. No.: 13/261,227

(22) PCT Filed: Aug. 3, 2010
(86) PCT No.: PCT/EP2010/061253

§ 371 Date: Mar. 22, 2012

(30) Foreign Application Priority Data
Sep. 22, 2009 (DE) 10 2009 029 670.0

(51) Int. Cl. F16K 1/44; F16K 17/02

(52) U.S. Cl. 137/512.2; 137/614.18

(57) ABSTRACT

In a non-return valve having a first closing body and a related first valve seat, and a second closing body and a related second valve seat, according to the invention the first and second valve seats are designed on a single valve seat component and the second valve seat is designed so as to surround the outside of the first valve seat.

### PRIOR ART

The invention relates to a non-return valve having a first closing body and an associated first valve seat as well as a second closing body and an associated second valve seat.

A non-return valve of the aforementioned type is known from German Patent Disclosure DE 103 39 250 A1, where it is installed in particular in a fuel injection system, for instance in order to open a connection in the direction of a leak fuel line on the one hand and on the other to fill a low-pressure reservoir. The lower valves of this non-return valve that are implemented with the two closing bodies and valve seats are intended to open and close at different line pressures. Among other things, the second valve seat is disposed on the second closing body.

### SUMMARY OF THE INVENTION

According to the invention, a non-return valve, in particular for a fuel injection device or a fuel injection system, such as a common rail system, is created having a first closing body and an associated first valve seat as well as a second closing body and an associated second valve seat, in which the first and second valve seats are embodied on a common or single valve seat component, and the second valve seat is embodied surrounding the first valve seat on the outside.

According to the invention, a non-return valve is created that has two connections, which serve in alternation as an inlet and outlet. Depending on the pressure ratios applied, two (lower) valves are switched in the non-return valve, and these valves are embodied with a first valve seat and an associated first closing body as well as a second valve seat and an associated second closing body. The valves are located in the same hydraulic space, and the valve seats of the two valves are embodied on a common, single valve seat component, or in other words one and the same valve seat component for these two valve seats, and the valve seat of one valve surrounds the valve seat of the other valve on the outside. In this way, a parallel arrangement of valves is created, which are spatially nested one inside the other. One advantage of this arrangement is that minimal space is required. By way of the geometry of the valve seats and closing bodies, as well as the spring forces or spring rates of associated spring elements, the pressure ranges and opening characteristics of the various flow rates can be adjusted. According to the invention, the valves are connected parallel in the tightest possible space and they preferably open and close in opposite directions, without requiring external actuation. According to the invention, the sealing function of whichever flow direction is blocked at the time is reinforced hydraulically. The opening at the respective closing body is “pressed tight”. Moreover, in the non-return valve of the invention, the spring forces of the two closing bodies do not affect one another, so that in a simple, economical way, a closing force that always meets the requirements can be ensured for both closing bodies. Moreover, in the non-return valve of the invention, the resultant masses to be moved in both valve motions are quite small, which has a favorable effect on the hydrodynamic performance of the individual valves.

In a first advantageous refinement of the non-return valve of the invention, the first valve seat is embodied as a central opening, and the second valve seat is embodied with a plurality of openings, which are disposed radially outward circumferentially around the first valve seat.

With this refinement, a valve seat arrangement that is dimensionally stable even at high pressures is created, which with the simultaneously achieved functional integration moreover requires especially little space.

In a second advantageous refinement of the non-return valve of the invention, the second closing body is embodied annularly.

The closing body of this kind can easily be prestressed by means of a helical spring against the associated valve seat, where it nevertheless provides very good sealing to the necessary extent. Advantageously, it achieves the aforementioned nesting of the two valves one inside the other.

In a third advantageous refinement of the non-return valve of the invention, the first closing body with a first spring element and the second closing body with a second spring element are formed in an axial direction against the associated valve seats, and the spring elements are embodied as overlapping in this axial direction.

This advantageous refinement also leads to further reduction in the space required, which moreover forms a fluidically favorable basis for an advantageous arrangement, described hereinafter, of a cartridgelike filter element.

In a fourth advantageous refinement of the non-return valve of the invention, two filter elements or filter cloths are provided, which are connected fluidically in series with the first and second valve seats, respectively.

The filter elements develop the filtering action in both flow directions, in each case upstream of the associated valve seat and its closing body, and thereby make it possible for both thus-protected valves not to be capable of becoming contaminated with particles. The valves are thus located between the filter elements in a space that is protected on both sides by filters.

According to the invention, a non-return valve, in particular for a fuel injection device or a fuel injection system, such as a common rail system, is also created, having a first closing body and an associated first filter cloth as well as a second closing body and an associated second filter cloth, in which the first and the second filter cloth are embedded in a common filter component.

The two filter cloths make purposeful filtration possible of fluid that is to be cleaned in each flow direction immediately upstream of the associated closing body or valve seat and thus ensure that the closing bodies with their associated valve seats are maximally protected against contamination. Simultaneously, the filter component created for the purpose is, as a multifunction component, especially inexpensive to produce and especially easy to install. Moreover, the above function of a valve seat component with the two associated valve seats is also especially advantageously integrated with the filter component.

In a fifth advantageous refinement of the non-return valve of the invention, the filter component is embodied with a hollow-cylindrical filter cartridge.

This kind of embodiment of the filter component advantageously makes a space-saving arrangement of the valve seats possible, in at least some portions, inside the filter cartridge. The filter cartridge is preferably closed on one of its face ends with an impact plate, against which the inflowing fluid flows. With the impact plate, a flow deflection of the fluid to be filtered is thus achieved. Hence the oncoming flow to the filter component is effected not via a stream aimed directly at the associated filter face; instead, the flow is first deflected. As a result, elongated particles inside the fluid are prevented from becoming oriented perpendicularly to the filter face. Instead, according to the invention, the particles are additionally made turbulent in the fluid flow. Alternatively or in addition, a pocket is advantageously embodied on the filter component and acts as a kind of dead-end street for receiving particles from the fluid flow. The particles are then collected in the pocket and do not plug up the filter component.

In a sixth advantageous refinement of the non-return valve of the invention, the filter cloths are embodied with a netting woven from two threads, of which one thread has a larger diameter than the other.

In this refinement, the warp and weft threads of the associated cloth are accordingly embodied as variously thick. In this way, in the netting, the result is triangular filter meshes or openings as opening faces in the cloth that are not located in the same plane as the filter cloth itself but instead are oriented obliquely to it. Within the cloth, a three-dimensional shape (a “3D filter”) is embodied, within which the opening faces are oriented obliquely to the primary plane of the cloth. The oblique orientation leads to an additional flow deflection, as a result of which long, thin particles are better intercepted.

In a seventh advantageous refinement of the non-return valve of the invention, the valve seat component at the same time retains the filter cloths.

With this refinement, the sealing functions for both hydraulic directions of operation and the filtering function are advantageously integrated in a single component. As a result, separate components for the above functions are dispensed with. The consequences are a cost advantage and a reduction in components, compared to previously known versions. Moreover, it is advantageous if sealing functions are simultaneously combined with retention functions of components. For instance, a cap is advantageously tightly welded to an associated housing, so that the housing is sealed off from the outside and at the same time the associated valve components are kept together. Also advantageously, the single valve component, which advantageously at the same time retains the filter cloth, is kept in position in the associated housing with a sealing seat. The connections of components with sealing functions are especially preferably made by means of laser welding, since in that way the two functions, the retention and the sealing functions, can be performed in integrated fashion, and otherwise necessary additional sealing or retaining elements can be dispensed with.

Moreover, it is advantageous in the invention if in a non-return valve, in particular of the type referred to above, at least one valve seat is embodied of a plastic reinforced with aramide fibers.

Compared to reinforcement with glass fibers, reinforcing a valve with aramide fibers or Kevlar leads to an improved property, in the sense that these filling fibers “catch” on one another as happens in cotton batting. Glass fibers lack this “tendency of catching”. With the catching of the filling fibers, any warping that occurs after the plastic injection molding operation is made homogeneous in all directions in space. Conversely, glass fibers have highly variable shrinkage in the fiber direction and 90° from the fiber direction. By means of the aramide fibers used according to the invention, uniform shrinkage and a high surface quality of the plastic part produced are conversely attained. This has advantages for the function of this part as a hydraulic sealing seat. Its sealing geometry is closer to the “ideal” form. Nonroundness or irregularities can be reduced. Moreover, according to the invention, the contact area of the sealing seat is advantageously enlarged in comparison to previously known versions. This is achieved in particular by means of a valve body that is especially large in diameter. This ensures better tightness in the event of irregularities in the associated valve seat and in the event of an input of particles during production or during operation. Moreover, the valve body is advantageously made from an elastomer material. Its geometry then adapts better to deviations in the associated sealing seat.

It is also advantageous according to the invention if in a non-return valve, in particular of the aforementioned embodiment, two components are joined together by means of a material-melting process, of which the first component is embodied with a first filler, in particular aramide fibers, and the second component is embodied with a second, different kind of filler, in particular glass fibers.

Accordingly, two plastics with different fillers are advantageously melted or welded to one another. Thus the advantages of both fillers (in particular aramide fibers and glass fibers) can be combined into a unit. The connection is embodied especially preferably by means of laser welding. The welding parameters can be adapted to the fillers in such a way that a homogeneous connection of the fundamental matrix exists. Alternatively, they can be embodied by means of friction welding, ultrasonic welding, soldering, or adhesive bonding.

One exemplary embodiment of the version according to the invention will be described below in conjunction with the accompanying schematic drawings. In the drawings:

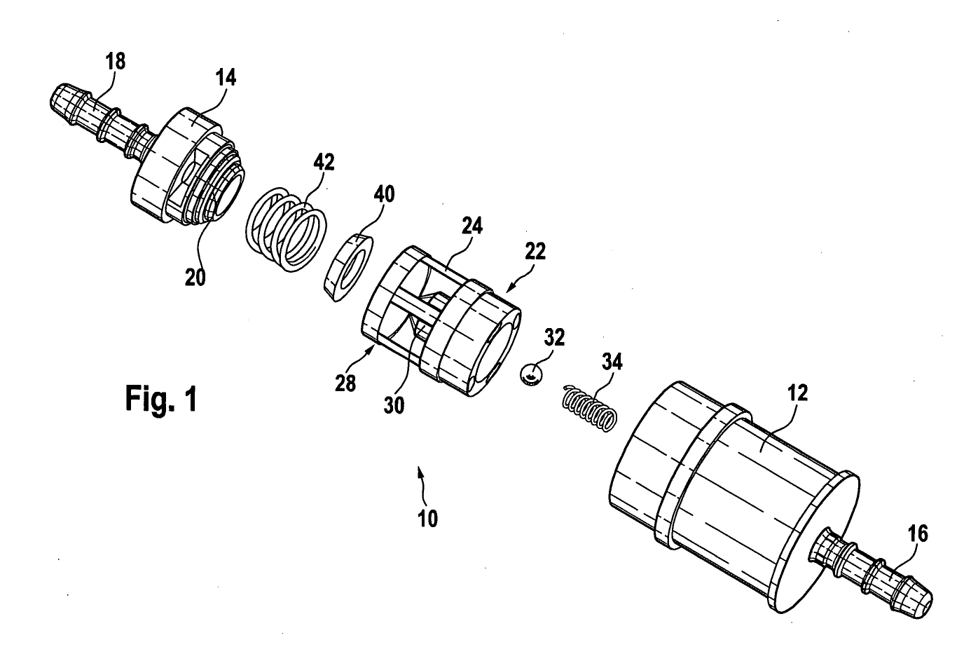

FIG. 1 is an exploded view of one exemplary embodiment of a non-return valve of the invention;

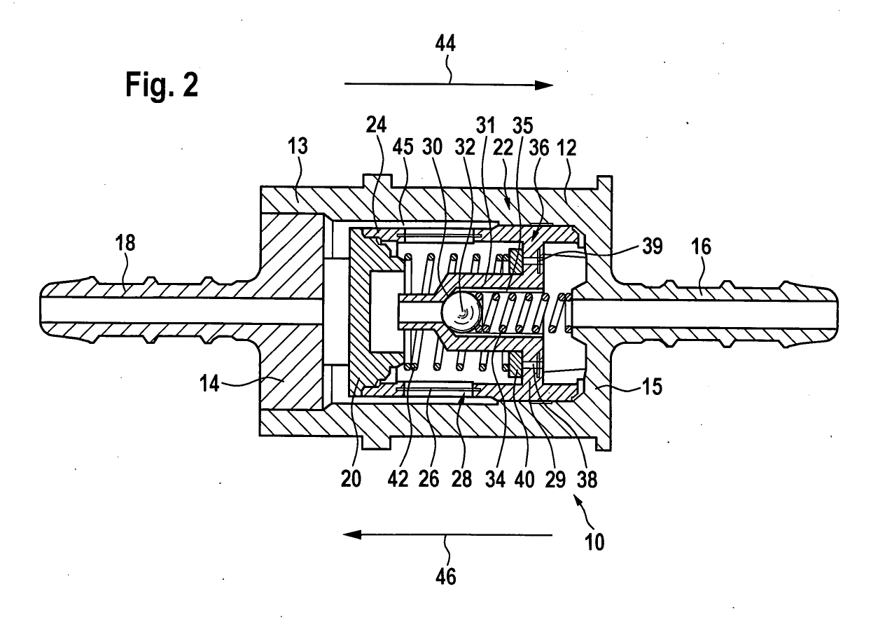

FIG. 2 is a longitudinal section through the non-return valve of FIG. 1;

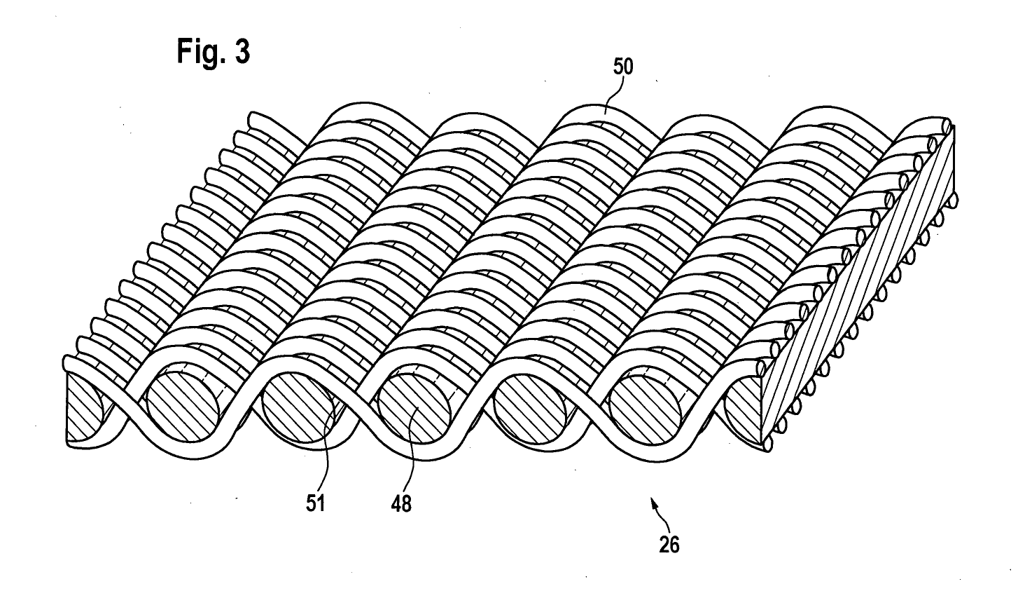

FIG. 3 is a perspective sectional view of a filter cloth of the non-return valve of FIG. 1;

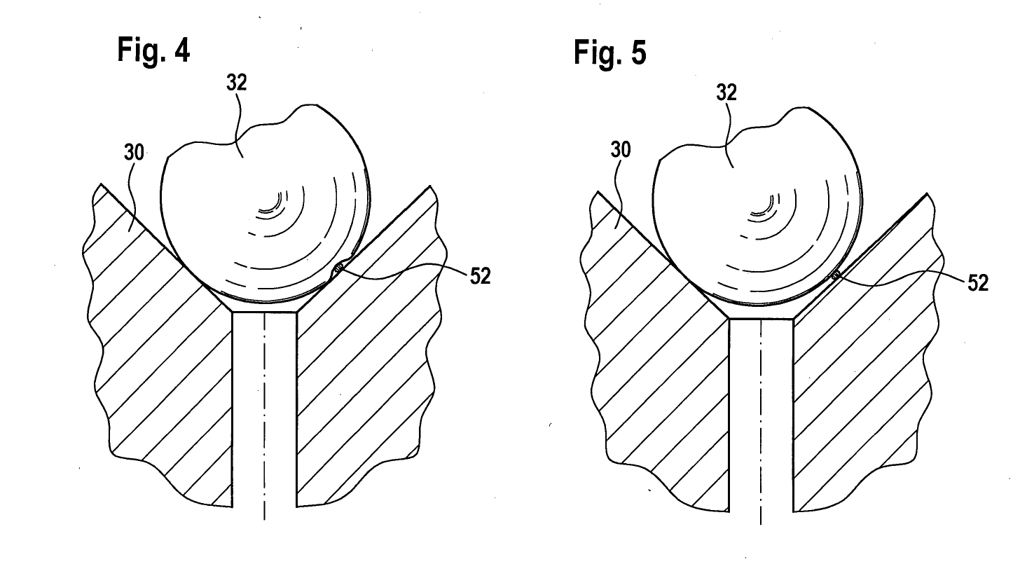

FIG. 4 is a longitudinal section through a valve seat with an elastomer closing body in the non-return valve of FIG. 1;

FIG. 5 is a longitudinal section through a valve seat with a steel closing body in the non-return valve of FIG. 1; and

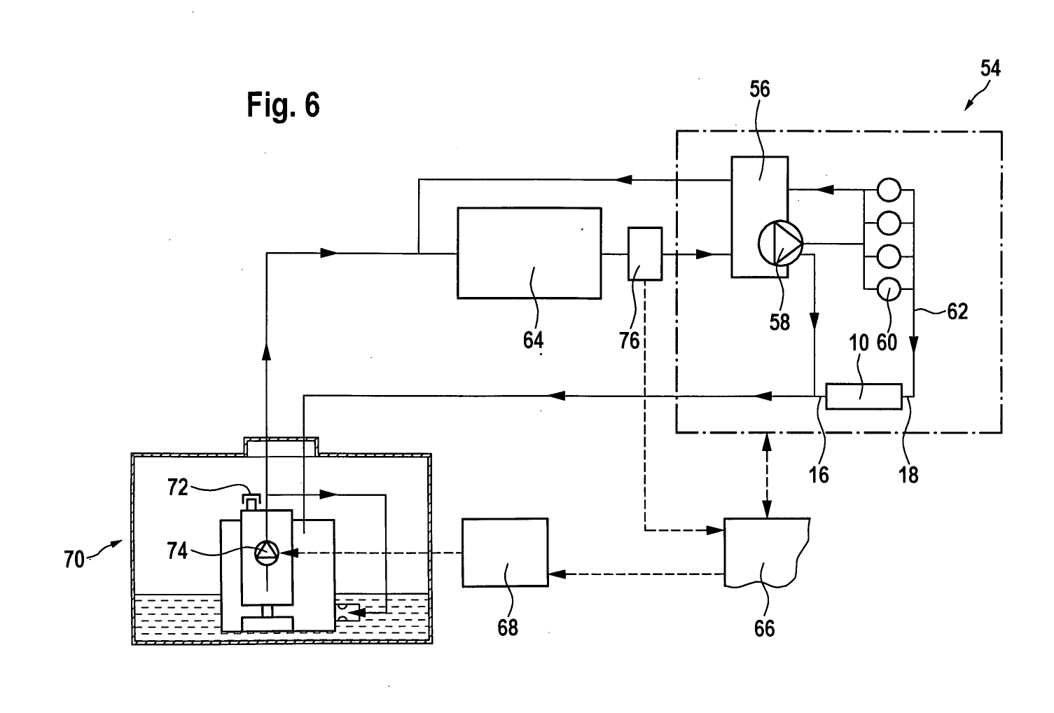

FIG. 6 is a circuit diagram of a fuel injection system having a non-return valve of FIG. 1.

In the drawings, a non-return valve 10 is shown especially for installation in a fuel injection system shown in FIG. 6, in the present instance a common rail system. The non-return valve 10 includes a cup-shaped housing 12, which is closed in fluid-tight fashion by a cap 14.

The housing 12 is embodied cylindrically, with a wall 13 of circular cross section and with an associated cover face 15. A hollow-cylindrical connection stub 16 is located on the cover face 15 of the housing 12 that is cup-shaped in this fashion. A hollow-cylindrical connection stub 18 is also located centrally on the outside of the cap 14. An impact plate 20 is embodied on the inside of the cap 14, parallel to this cap.

An insert 22 is inserted to fit into the housing 12 and will also here be called a valve seat component. The insert 22 is embodied circular-cylindrically and is essentially hollow on the inside. The impact plate 20 closes the otherwise open end, toward the cap 14, of the insert 22. The connection between the cap 14 and insert 22 is made and sealed off by means of laser welding. The cap 14 has been injection-molded beforehand with a plastic reinforced with glass fibers, and the insert 22 has been injection-molded beforehand with a plastic reinforced with aramide fibers.

A plurality of windowlike recesses are located in the jacket face of the insert 22 and with the remainder of the jacket face they form a cage 24. A filter cloth 26 (this has been left out of FIG. 1 for the sake of better illustration) is disposed in the windowlike recesses in the insert 22 in such a way that these recesses or windows are spanned by the filter cloth 26 (see FIG. 2). In the production of the insert 22, the filter cloth 26 has been placed in an associated injection mold and inserted or cast integrally into the component by means of injection molding. A form-locking connection has thus been made between the material of the insert 22 and the filter cloth 26. Thus the cage 24, together with the filter cloth 26, forms a filter component 28.

In the interior of the insert 22, in the end region facing away from the cap 14, there is a disklike portion 29, the middle of which is adjoined by a hollow-cylindrical portion 31. A first valve seat 30 is embodied centrally in the hollow-cylindrical portion 31. The valve seat 30 is funnel-shaped and circular. Together with the hollow-cylindrical portion 31, it defines a hollow space, opposite the cover face 15 of the housing 12, in which hollow space there is a spherical closing body 32. The closing body 32 is forced against the valve seat 30 by a helical spring 34, as a spring element. The helical spring 34 is braced by one of its ends on the cover face 15 of the housing 12. In this position, the helical spring 34 is prestressed and is guided together with the closing body 32 in the interior of the hollow space by means of guide ribs 35.

A second valve seat 36 is also embodied on the insert 22; it surrounds the first valve seat 30 on its outside, outside the hollow-cylindrical portion 31. This second valve seat 36 is formed by a plurality of conduits 38, which are disposed at regular intervals around the valve seat 30. A filter cloth 39 extends, oriented transversely, as a filter element in each of the conduits 38.

An annular closing body 40 is associated with the valve seat 36 and can move in the axial direction of the non-return valve 10, and thus of the cup-shaped housing 12, along the hollow-cylindrical portion of the insert 22. A second helical spring 42, as a spring element, presses with one of its ends against the closing body 40 and is braced on the impact plate 20 of the cap 14. It is likewise prestressed in this position.

Via the connection stubs 16 and 18, the non-return valve 10 can experience a flow of fluid, in the present case fuel, in alternation from one or the other side. The flow through the connection stub 18 is the normal operating state for the non-return valve 10. The flow through the connection stub 16 serves to fill what is then the downstream fuel injection system the first time it is put into operation and to build up a counterpressure as applicable in this downstream fuel injection system during operation.

If in the normal operating state the fluid is flowing in the direction of an arrow 44 shown in FIG. 2, then after passing through the connection stub 18, it strikes the impact plate 20. At the impact plate 20, the fluid flows deflected from the axial direction to the radial direction. After that, the fluid flows onward in the axial direction along the outside of the filter component 28 and must change its flow direction again so that it can pass radially inward through the filter cloth 26. With these deflections, particles in the fluid flow are made turbulent by eddy currents that arise. Specifically, elongated particles in the fluid flow are thus prevented from being able to be oriented in the flow direction. Otherwise, these elongated particles would meet the associated filter faces at a right angle and, despite their size (or length), would pass through the filter. The turbulence conversely prevents this kind of orientation in the flow direction and as a result maximum filtration action is achieved.

Accordingly the fuel flows along the impact plate 20 and finally flows between the housing 12 and the insert 22. A gap 45 extending all the way around there between the housing 12 and the insert 22 is indeed narrow, but because of the large circumference of the insert, it nevertheless furnishes a large flow cross section and thus low flow resistance. The fuel is pressed by hydraulic pressure through the filter cloth 26 and in the process is freed of particles. The hydraulic pressure of the fuel flow exerts a force in the direction of the arrow 44 on part of the face of the spherical closing body 32. This force displaces the closing body 32 counter to the spring force of the helical spring 34. The valve seat 30, previously closed by the closing body 32, is thus passable, and the fuel leaves the non-return valve 10 through the connection stub 16. The filter cloth 26 is associated with the closing body 32 and in particular protects it against contaminants.

The hydraulic pressure that effects a displacement of the closing body 32 at the same time exerts a force on the face of the annular closing body 40. This force acts in the direction of the arrow 44 and of the spring force of the helical spring 42. With the combination of the two forces, a sealing function of the closing body 40 is hydraulically reinforced.

If for filling purposes, fluid approaches or flows through the non-return valve 10 from right to left in the direction of an arrow 46 shown in FIG. 2, then the fuel after passing through the connection stub 16 reaches the conduits 38. There, the fuel flow through the filter cloth 39 and is likewise freed of particles. The hydraulic pressure lifts the annular closing body 40 from the valve seat 36. The closing body 40 moves counter to the spring force of the helical spring 42 and allows a further flow of the fuel into the interior of the insert 22. The filter cloth 39 is associated with the closing body 40 and protects it in particular from contaminants.

At the same time, the hydraulic pressure in the direction of the arrow 46 reinforces the sealing function of the closing body 32 at the valve seat 30.

The fuel now flows in the direction of the filter component 28, and the flow is deflected by the annular closing body 40. As a result of the deflection of the flow, eddies occur, which also optimize the filtration action of the filter component 28. After passing through the filter cloth 26, the fuel flows between the housing 12 and the insert 22 through the gap 45 in the direction of the cap 14 and leaves the non-return valve 10 through the connection stub 18.

FIG. 3 shows the filter cloth 26 or 39 in detail. It includes warp threads 48 and weft threads 50. The warp threads 48 have a considerably larger diameter than the weft threads 50. As a result, one (essentially) triangular mesh opening 51 per filter mesh is created in the filter cloth 26 at the individual warp thread 48 between two adjacent weft threads 50. These mesh openings 51 have an angle in the range from 30° to 60°, preferably 45°, to the cross-sectional area of the warp threads 48. Within the cloth, the filter area through which there is to be a flow is thus put into a three-dimensional form (a “3D filter”). The oblique orientation of the mesh openings 51 causes an additional flow deflection, and as a result, long, thin particles can be better intercepted.

The filter cloths 26 and 39 have been integrated in a single operation by embedding in the insert 22, otherwise made from plastic, as a filter component 28. The filter cloth 26 and the filter cloth 39 have been prefabricated, either in one piece as a cup-shaped filter element, or as in the present case as two individual filter elements, one of which is disk-shaped and the other is hollow-cylindrical.

FIG. 4 in detail shows the valve seat 30, which here is embodied of a plastic reinforced with aramide fibers, and the associated closing body 32. A particle 52 has been deposited on the valve seat 30. The closing body 32 is made from elastomer material. It is therefore capable of good elastic deformation and is able to deform beyond the particle 42. Therefore despite the particle 52 on the valve seat 30, it provides sealing. Because of its elastic deformability, the closing body 32 can in general adapt especially well to different surface structures and as a result can compensate for deviations in the surface of the associated valve seat 30.

In FIG. 5, in comparison, the situation of FIG. 4 can be seen with a closing body 32 that is made from a steel material. This closing body does not have the aforementioned elastic properties. It therefore rests on the particle 52 in such a way that a crescent-shaped gap is created. Fuel can flow through this gap.

FIG. 6 shows the fuel injection system with the non-return valve 10 built in. The fuel injection system is part of an engine 54, to which liquid fuel can be delivered via a pressure limiting valve 56 by means of an injection pump 58. The fuel is fed to cylinders 60, where the fuel is injected and combusted. Excess fuel injected reaches a return line 62.

The fuel reaches the pressure regulating valve 56 through a pressureproof filter 64, and an engine control unit 66 is provided that controls this fuel delivery. The engine control unit 66 is also operationally coupled to a tank pump control unit 68.

The fuel is stored in a tank 70, and on the tank a pressure limiting valve 72 is provided as a safety valve. From the tank 70, the fuel is pumped out by means of a tank pump 74. The tank pump 74 pumps the fuel with pressure (mean pressure up to approximately 6 bar) to the pressureproof filter 64, and this fuel feeding is controlled by means of the tank pump control unit 68. The pressureproof filter 64 clears the fuel of contaminants.

Downstream of the pressureproof filter 64, a fuel cooler with a temperature sensor 76 is disposed in the associated line. The fuel is pumped through, this fuel cooler to the pressure limiting valve 56. From there, the fuel either reaches the cylinders 60, or through a ring line returns to upstream of the pressureproof filter 64, or flows back into the tank 70.

The flow to the cylinders 60 is carried out in the high-pressure range (markedly above 6 bar) by means of the injection pump 58 and serves to combust the fuel as well as to actually operate the engine 54. In the cylinders 60, chemical energy of the fuel is converted into mechanical work by combustion.

The return flow to upstream of the pressureproof filter 64 serves to cool the fuel (at average pressure). In the process, the thermal energy absorbed by the fuel at the pumps 58 and 74 is given up again. The temperature sensor 76 reports the temperature of the fuel flow to the engine control unit 66. The engine control unit 66, via the tank pump control unit 68, controls the fuel flow to the pressureproof filter 64. As a result, the quantity of thermal energy extracted from the fuel flow is regulated.

The return flow to the tank 70 serves to carry away excess fuel and is done at low pressure (below approximately 1.8 bar).

The fuel that reaches the cylinders 60 is for the most part injected there. The pressure regulating valve 56 compensates for pressure fluctuations on its input side, so that on its output side, a constant output pressure prevails. With the aid of the high-pressure-generating injection pump 58, the injection at the cylinders 60 is then subsequently additionally based on an overpressure regulation, from which the excess fuel is pumped back directly to the pressure limiting valve 56.

The injection pump 58, at the onset of its pumping, pumps an excess, which is returned to the tank 70 through the non-return valve 10. The return of the excess fuel is done in the direction of the arrow 44 in FIG. 2.

In the starting phase of the motor 54, the aforementioned filling of the engine system or the furnishing of counterpressure downstream of the cylinders 60 is necessary. This filling with fuel is likewise done by means of the injection pump 58. For that purpose, the injection pump 58, as shown in FIG. 2, forces the fuel in the direction of the arrow 46 through the non-return valve 10.

1-12. (canceled)

13. A non-return valve having a first closing body and an associated first valve seat as well as a second closing body and an associated second valve seat, the first valve seat and the second valve seat being embodied on a common valve seat component, and the second valve seat being embodied as surrounding the first valve seat on the outside.

14. The non-return valve as defined by claim 13, wherein the first valve seat is embodied as a central opening, and the second valve seat is embodied with a plurality of openings, which are disposed radially outward circumferentially around the first valve seat.

15. The non-return valve as defined by claim 13, wherein the second closing body is embodied annularly.

16. The non-return valve as defined by claim 14, wherein the second closing body is embodied annularly.

17. The non-return valve as defined by claim 13, wherein the first closing body with a first spring element and the second closing body with a second spring element are forced in an axial direction against the associated valve seats, and the spring elements are embodied as overlapping in this axial direction.

18. The non-return valve as defined by claim 16, wherein the first closing body with a first spring element and the second closing body with a second spring element are forced in an axial direction against the associated valve seats, and the spring elements are embodied as overlapping in this axial direction.

19. The non-return valve as defined by claim 13, wherein two filter elements are provided, which are connected fluidically in series with the first valve seat and the second valve seat, respectively.

20. The non-return valve as defined by claim 18, wherein two filter elements are provided, which are connected fluidically in series with the first valve seat and the second valve seat, respectively.

21. The non-return valve as defined by claim 13, having a first closing body and an associated first filter cloth as well as a second closing body and an associated second filter cloth, characterized in that the first filter cloth and the second filter cloth are embedded in a common filter component.

22. The non-return valve as defined by claim 20, having a first closing body and an associated first filter cloth as well as a second closing body and an associated second filter cloth, characterized in that the first filter cloth and the second filter cloth are embedded in a common filter component.

23. The non-return valve as defined by claim 21, wherein the filter component is embodied with a hollow-cylindrical filter cartridge.

24. The non-return valve as defined by claim 21, wherein the first filter cloth and the second filter cloth of the filter component are embodied with a netting woven from two threads, of which one thread has a larger diameter than the other.

25. The non-return valve as defined by claim 23, wherein the first filter cloth and the second filter cloth of the filter component are embodied with a netting woven from two threads, of which one thread has a larger diameter than the other.

26. The non-return valve as defined by claim 21, wherein the valve seat component simultaneously retains the first filter cloth and the second filter cloth.

27. The non-return valve as defined by claim 23, wherein the valve seat component simultaneously retains the first filter cloth and the second filter cloth.

28. The non-return valve as defined by claim 24, wherein the valve seat component simultaneously retains the first filter cloth and the second filter cloth.

29. The non-return valve as defined by claim 13, wherein at least one valve seat is embodied of a plastic reinforced with aramide fibers.

30. The non-return valve as defined by claim 13, wherein two components are joined together by means of a material-melting process, of which the first component is embodied with a first filler composed of aramide fibers, and the second component is embodied with a second, different kind of filler, composed of glass fibers.

31. A fuel injection system having a non-return valve as defined by claim 13.

32. A fuel injection system having a non-return valve as defined by claim 22.
